(19) United States
(12) Patent Application Publication
(10) Pub. No.: US 2025/0265459 A1
(43) Pub. Date: Aug. 21, 2025

(54) COMPRESSED TENSOR NETWORK GENERATION USING DIFFUSION MODELS

(71) Applicant: Dell Products L.P., Round Rock, TX (US)

(72) Inventors: João Victor da Fonseca Pinto, Rio de Janeiro (BR); Micael Veríssimo de Araújo, Rio de Janeiro (BR); Miguel Paredes Quiñones, Campinas (BR)

(21) Appl. No.: 18/583,832

(22) Filed: Feb. 21, 2024

(51) Int. Cl. G06N 3/08; G06N 3/0475

(52) U.S. Cl. CPC G06N 3/08; G06N 3/0475

(57) ABSTRACT

One example method includes providing an input to a generative model that was trained using a training dataset, and the input comprises a feature set of a quantum circuit, performing, with the generative model, a reverse phase process that removes noise from one or more training samples that were used to train the generative model, in conjunction with the reverse phase process, consulting, by the generative model, a guidance loss, and generating, based in part on the guidance loss, a set of samples, and one of the samples comprises a tensor network that represents the quantum circuit.

### FIELD OF THE INVENTION

Embodiments of the present invention generally relate to the generation of representations of quantum circuits. More particularly, at least some embodiments of the invention relate to systems, hardware, software, computer-readable media, and methods for, the use of diffusion models to generate tensor networks that represent quantum circuits.

### BACKGROUND

Tensors are multi-dimensional arrays of numbers, and example tensors are generalization of scalars (tensor rank 0), vectors (tensor rank 1), and matrices (tensor rank 2). Recently the use of Tensor Networks (TN) has emerged as an alternative approach for modeling complex quantum systems. This is due to the ability of the TN to represent large Quantum Circuits (QC), and to the reduced computational cost associated with manipulating TNs. Further, it is possible, when simulating a large QC, to reduce the overhead, such as processing costs, of the simulation by using TNs.

Despite these advantages however, the transformation from a QC to a low-order TN is not direct and, presently, must be designed by hand in order to obtain the best representation for a given QC. A possible embodiment to obtain a TN representation is by using tensor Singular Value Decomposition (SVD), where the main idea is to represent a representative part of Hilbert space that is similar to the original portion that the original circuit is representing, a low entangelement state for example, using repeated application of the SVD to obtain low-rank approximations. However, this process has high timing and computational costs.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of some example TN architectures that may be employed in an embodiment.

FIG. 1a discloses aspects of an example TN contraction operation such as may be employed in an embodiment.

FIG. 2 discloses aspects of some example QCs with the same connectivity as the TN architectures disclosed in FIG. 1.

FIG. 3 discloses a training process for a DM (diffusion model) according to one embodiment.

FIG. 4 discloses a process, according to one embodiment, in which a QC is provided as an input, and a corresponding TN is obtained as an output.

FIG. 5 discloses an example computing entity configured and operable to perform any of the disclosed methods, processes, and operations.

### DETAILED DESCRIPTION OF SOME EXAMPLE EMBODIMENTS

Embodiments of the present invention generally relate to the generation of representations of quantum circuits. More particularly, at least some embodiments of the invention relate to systems, hardware, software, computer-readable media, and methods for, the use of diffusion models to generate tensor networks that represent quantum circuits.

One example embodiment comprises a method that may comprise the following operations: generating a training dataset that comprises a set of tuples (Tᵢₙₚᵤₜ, C) (where Tᵢₙₚᵤₜ is a known representation of a TN, and C is the QC to which that representation corresponds); using the training dataset to train, with a guidance loss and using forward and reverse noise processes, a DM so that the DM is able to generate, using a QC as a given or input condition, a TN corresponding to that QC; and, using the trained DM to generate a TN for a given QC.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment is that a TN may be generated that represents a QC. In an embodiment, a TN representation of a QC may be used, instead of the QC itself, for quantum simulations. In this case, the TN may provide a savings in computational resources, used to carry out the quantum simulation, relative to the computational resources that would be required if the QC were not simulated by the TN. Various other advantages of one or more example embodiments will be apparent from this disclosure.

### A. Context for an Example Embodiment

The following is a discussion of aspects of one context for an embodiment of the invention. This discussion is not intended to limit the scope of the invention, or the applicability of the embodiments, in any way.

### A.1 Tensor Networks

Tensors are multidimensional arrays that can be categorized in using a hierarchy according to their order. An advantage to using this type of representation is how the mathematical operations, such as contractions, are encoded, which may be simpler than in other approaches. In order to define a TN, it may be important to understand what a tensor contraction operation is. In general, then, a tensor contraction operation is an operation in which two or more tensors are contracted by summing over repeated indices.

Knowing this, a TN is a collection of tensors in which a subset of all indices for those tensors is contracted. A TN may represent complicated operations that can involve several tensors with many indices contracted in a sophisticated pattern.

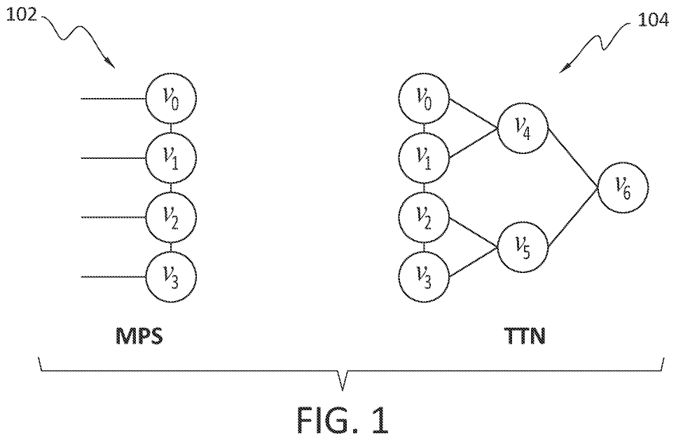

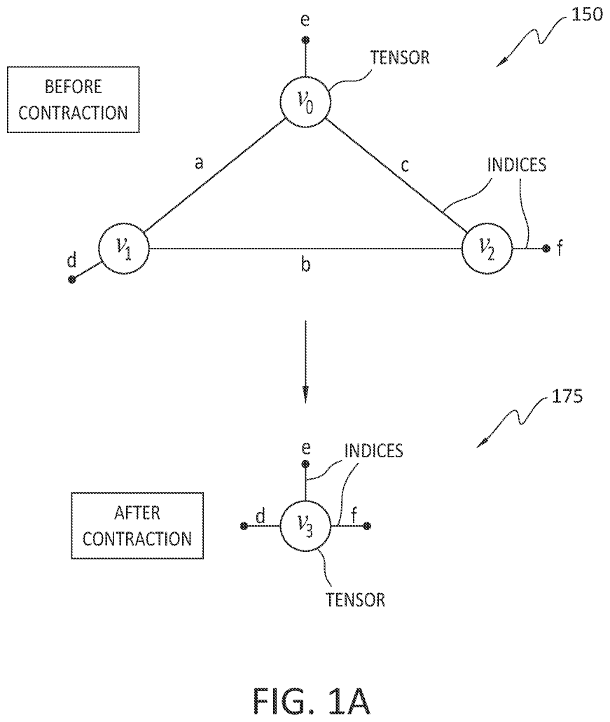

Two examples of TN architectures are disclosed in the example of FIG. 1. In particular, FIG. 1 discloses a Matrix Product State (MPS) 102 and a Tree Tensor Network (TTN) 104. Each of these example TN architectures may comprise a specific pattern of connection between tensors, and may have a flexible number of indices.

With reference briefly to FIG. 1a, an example of a contraction operation is disclosed. Prior to contraction, a TN 150 may comprise various tensors V₀, V₁, and V₂. The tensors may each be associated with various indices. For example, the indices a, b, and c, may connect the tensors to each other. As shown, index a, for example, is common to both tensor V₀ and tensor V₁. Thus, the TN 150 may be a candidate for a contraction operation. In addition to the common indices, each of the tensors may have other indices as well, such as d, e, and f, for example.

After the contraction operation is performed on the TN 150, a contracted TN, TN 175 in this example, may result. As shown, TN 175 may comprise a single tensor V₃ that is connected to the indices d, e, and f, while the indices a, b, and c, are no longer present.

### A.2 Tensor Networks to Represent Quantum Circuits

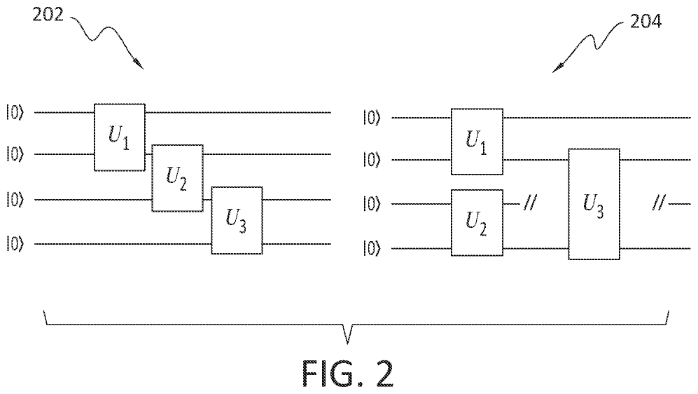

A QC may be represented as a TN, and it is possible to design a QC that may have the same connectivity as represented by the MPS 102 and the TTN 104, for example. It is noted that the connectivity of a TN is intrinsically related to how quantum entanglement of the QC is distributed and how correlations spread in the resulting Tensor Network Quantum Circuit (TNQC). In TNQC, the TN architecture may serve as a guideline for the shape of the QC. As shown in the examples of FIG. 2, the TNQCs 202 and 204 may have the same connectivity, respectively, as the MPS 102 and TTN 104 in FIG. 1.

### A.3 Diffusion Models

Diffusion models (DM) are a deep learning architecture that may be used for the generation of synthetic data, as noted in “Rombach, R., Blattmann, A., Lorenz, D., Esser, P. and Ommer, B., 2022. High-resolution image synthesis with latent diffusion models. In Proceedings of the IEEE/CVF Conference on Computer Vision and Pattern Recognition (pp. 10684-10695)” which is incorporated herein in its entirety by this reference. Although there are many types of DM, they all share a basic premise and working mode. Particularly, these models involve gradually adding small amounts of noise, such as Gaussian noise for example, to samples, in a large number of steps, until the sample is highly specific to, and follows, a strict scheduling that is determined from the underlying mathematical formulation of DMs. This noise adding process is usually done in what is referred to as a forward diffusion process.

After the noise has been added, a reverse diffusion process may then be performed. In a reverse diffusion process, the noisiest sample, obtained by the forward diffusion process, has a small amount of noise removed at each of multiple steps until what remains is a sample that resembles the original sample before any noise was added.

At the end a main objective is learn how to noise, and denoise, a training dataset. Once this process is learned, the DM that was trained with the training dataset may be able to generate, by using the reverse process, a new synthetic data that belongs to the real data distribution. Also, techniques as denoise diffusion are used to take off noise form images to recreate the original image.

### A.3.1 Conditioned Generation

During the development of a generative models such as DMs, it may be possible to impose conditions on the generated data, in order to give a user more control with respect to the characteristics of the synthetic data. There are various ways to do this, such as text prompting, image prompting, and loss guidance, for example. A DM may be also trained for a conditioned generation task, where the synthetic data should obey the constraints imposed by the user.

### B. Overview of Aspects of an Example Embodiment

In the context of simulating a QC in an optimized way, an example embodiment may employ a TN for QC simulation, since such an approach may speed up the simulation, relative to an approach that does not use a TN for QC simulation, which may provide various advantages, particularly when dealing with a large QC.

Although a transformation from QC to TN with the aim of obtaining a compressed representation, that is, the TN, of the QC, is not direct and must be considered case by case with the application tensor SVD, an embodiment may deal effectively with this inasmuch as an embodiment may comprise a generative model to obtain the TN representation from a given QC. According to an embodiment, the generative model employed is a DM) which is a method inspired by the physical process of gas diffusion. In brief, in an embodiment, a DM is trained to diffuse the various TN representations, and the QC is used as the condition for the generated TN.

In more detail, an embodiment may employ a generative modeling approach, such as a DM, to create a TN to represent a QC, thus possibly enabling a reduction in computational required to simulate a QC. This may be particularly useful in cases where large QCs may require significant computational resources to be simulated using techniques other than a generative modeling approach.

In an embodiment, the generative model, such as a DM for example, may be used to create the TN, T_{gen}, representation given a QC C a priori. In this case, the DM may be trained using a dataset with tuple of already known TN representations and their QC (Tᵢₙₚᵤₜ, C). In a diffusion, or forward, phase of the training, the DM may learn how to add noise to the Tᵢₙₚᵤₜ until all that remains is the Gaussian, or other, introduced noise. In the subsequent, reverse phase, of the training, Markov Chains (MC) may be used to obtain the T_{gen} from the Gaussian noise that remains at the end of the diffusion phase. At the conclusion of this process, the DM has been transformed into a TN generator, but this generator has not yet been conditioned by any specific QC. Thus, in order to introduce the QC as a condition to the TN generator, an embodiment may apply a conditioned loss to the TN generator to obtain a TN that has the QC C as a priori.

In an embodiment, this conditioned loss may have a tolerance factor (ϵ) to reduce the range of possibilities of generated TN based on the priori C. This tolerance factor may be driven by tensor contraction measurement, which may provide the possibility to reduce even more the computational cost generating the TN to simulate C.

Finally, an embodiment may use the trained TN generator to obtain the appropriate TN from a given QC in its TN form Tᵢₙₚᵤₜ, and then use this generated TN T_{gen} instead of the QC itself in the simulation in order to save computational resources.

As disclosed herein then, an embodiment may comprise various useful features and aspects, although no embodiment is required to possess any of such useful features and aspects.

Following are some examples. An embodiment may comprise a method to train a DM to obtain, or create, a TN generator that has a QC as condition priori. As another example, the QC and TN encoding may evaluate the condition loss applied during the training. In an embodiment, the DM approach may generate a TN that is compressed representation of a QC. Further, an embodiment may use the T_{gen} for quantum simulations represents computational resource savings in comparison to the use of the original Tᵢₙₚᵤₜ.

### C. Detailed Discussion of Aspects of an Example Embodiment

One example embodiment may employ a dataset needed and a training process to obtain a TN generator that comprises a conditioned DM. Details concerning an example dataset, and training process are set forth below.

### C.1 Dataset

In an embodiment, a dataset used to train the DM may comprise a QC C and their respective TN T_{C}, so in this example case, each sample from the dataset is well described by the tuple (Tᵢₙₚᵤₜ, T_{C}). Note that the Tᵢₙₚᵤₜ here may be represented as graph that comprises all contractions need to best represent the QC C, and T_{C} is the graph that may be processed in order to reduce the representation of Tᵢₙₚᵤₜ.

### C.2 Training

Given the tuple (Tᵢₙₚᵤₜ, T_{C}) from above, a DM training process according to one embodiment may use, in a forward phase of the training, the TN T_{C} in order to add noise until only the noise remains. An embodiment may use Tᵢₙₚᵤₜ as a feature for the DM to guide performance of the diffusion process, that is, the forward phase. To aid in this process, in an embodiment, various schedulers may be employed, with the objective to lend further control to performance of the diffusion process.

In an embodiment, a reverse phase of the training may be performed after the forward phase has been completed, that is, after Tᵢₙₚᵤₜ is no longer present and all that remains is the Gaussian, or other, introduced noise. In an embodiment, the reverse phase may begin with noisy generated data and with an appropriate loss guidance that should returns, at the end of the reverse phase, a new TN T_{gen}. In an embodiment, the loss guidance may use features extracted from the QC C. Some examples of such features are a Directed Acyclic Graph (DAG) representation of QC, and the number of CNOT gates in the QC.

With this information obtained from the QC, an encoder of the generator may use this information as a condition for the generation task by using a guidance loss. This guidance loss, alongside of the training loss, may be directed to the objective of controlling the generator so that the generator does not generate a TN that does not accurately represent the conditioned task, which is represented by, or comprises, the QC.

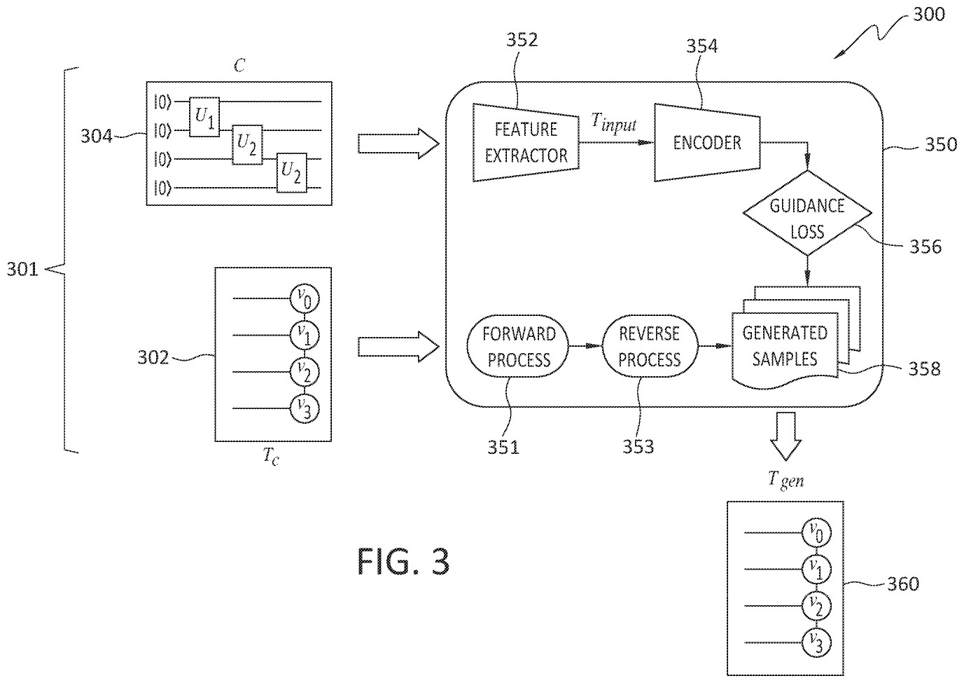

With attention now to FIG. 3, an example training process 300 according to one embodiment is disclosed that uses a guidance loss. In general, the guidance loss may be used, in the process 300, to control the generation phase of the process 300. As shown, one or more tuples 301, each comprising a TN architecture Tᵢₙₚᵤₜ 302, and associated C 304 comprising, or represented by a TNQC, may be provided as training data to the DM 350.

In an embodiment, the DM 350 may comprise a feature extractor 352 that may extract Tᵢₙₚᵤₜ 302 from the C 304 of the input tuple(s) and provide Tᵢₙₚᵤₜ 302 to an encoder 354 of the DM 350. This extracted information, or features, may be used as a condition for creation or definition of a guidance loss 356 which may be employed as described below. Alongside the feature extraction, the DM 350 may perform a forward phase 351 on the Tᵢₙₚᵤₜ 302 by adding noise to the Tᵢₙₚᵤₜ 302 until only noise remains. After the forward phase 351 is completed, the DM 350 may then perform a reverse phase 353 in which the noise is gradually extracted until, guided and controlled by the guidance loss 356, one or more samples 358 are generated by the DM 350. The samples 358 may comprise one or more TN architectures, T_{gen} 360, that do not represent the conditioned task, represented by C 304. That is, for example, the samples 358 may be different from the Tᵢₙₚᵤₜ 302.

### C.3 Operation

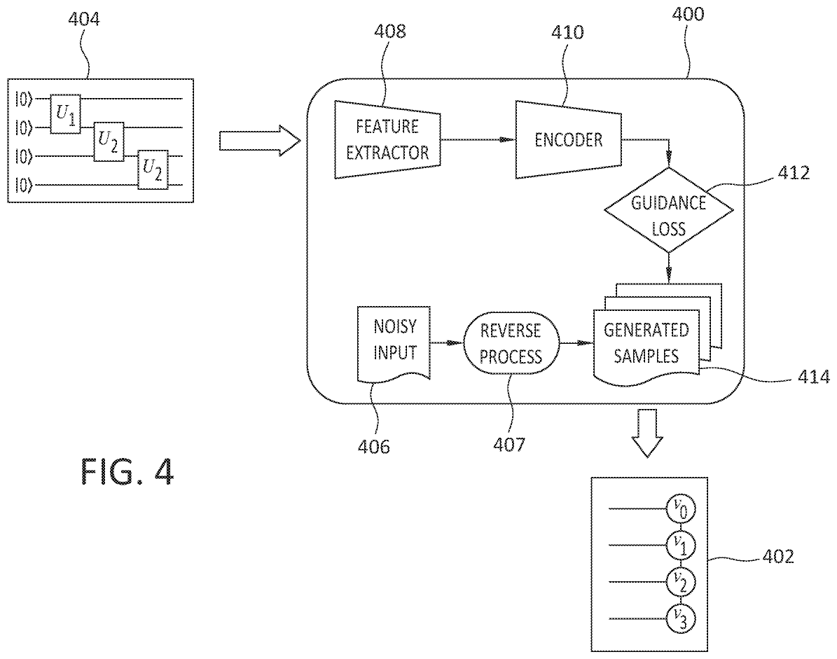

Once the training process, such as the process 350 for example, is finalized, and with reference now to FIG. 4, the DM 400 may have the ability to generate a new TN 402 that simulates a QC 404 that the DM 400 has not seen before. It is noted that in the example of FIG. 4, only the QC 404 is provided as input to the DM 400, and the DM 400 uses a pure noisy input 406 in the reverse phase. As discussed below, the DM 400 may operate similarly to the DM 350 except as noted.

For example, the feature extractor 408 may extract various features from the QC 404 and then pass those features to the encoder 410. This extracted information, or features, may be used by the encoder 410 as a condition for creation or definition of a guidance loss 412. Alongside this feature extraction process, a reverse phase 407 may be performed, using the noisy input 406, that results in the generation, as directed by the guidance loss 412, of samples 414 by the DM 400. In contrast with the process 300 and associated samples 358, the samples 414 may comprise one or more TN architectures, T_{gen} 402, that accurately represent the conditioned task, which is represented by C 404.

### D. Example Methods

It is noted with respect to the disclosed methods, including the example methods of FIGS. 3 and 4, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments of the invention. These are

presented only by way of example and are not intended to limit the scope of the invention in any way.

Embodiment 1. A method, comprising: providing an input to a generative model that was trained using a training dataset, and the input comprises a feature set of a quantum circuit; performing, with the generative model, a reverse phase process that removes noise from one or more training samples that were used to train the generative model; in conjunction with the reverse phase process, consulting, by the generative model, a guidance loss; and generating, based in part on the guidance loss, a set of samples, and one of the samples comprises a tensor network that represents the quantum circuit.

Embodiment 2. The method as recited in any preceding embodiment, wherein the generative model is a diffusion model.

Embodiment 3. The method as recited in any preceding embodiment, wherein the generative model was trained by a forward phase process comprising adding noise to the one or more training samples.

Embodiment 4. The method as recited in any preceding embodiment, wherein the training dataset comprised a group of tuples (Tᵢₙₚᵤₜ, C), where Tᵢₙₚᵤₜ is a known representation of a tensor network, and C is a quantum circuit to which that representation corresponds.

Embodiment 5. The method as recited in any preceding embodiment, wherein the tensor network is a contracted tensor network created from a group of tensor networks.

Embodiment 6. The method as recited in any preceding embodiment, wherein the generative model comprises an encoder that uses the feature set as a basis to generate the guidance loss.

Embodiment 7. The method as recited in any preceding embodiment, wherein the reverse phase process is performed using Markov chains.

Embodiment 8. The method as recited in any preceding embodiment, wherein the tensor network generated as part of one of the samples is a compressed version of the quantum circuit.

Embodiment 9. The method as recited in any preceding embodiment, wherein the reverse phase process is performed using a pure noisy input.

Embodiment 10. The method as recited in any preceding embodiment, wherein the generative model is operable to generate the tensor network representative of the quantum circuit, using only the feature set of the quantum circuit as the input.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

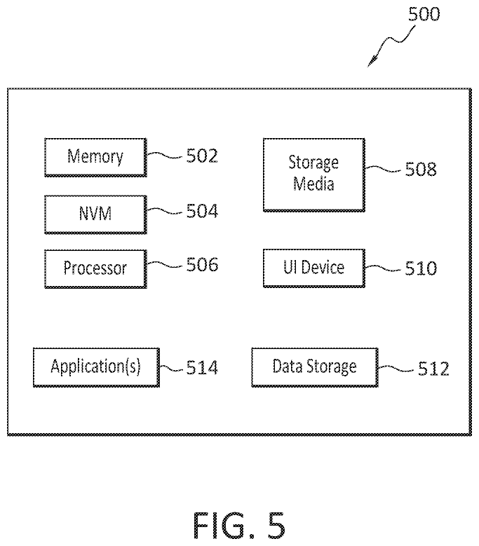

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
providing an input to a generative model that was trained using a training dataset, and the input comprises a feature set of a quantum circuit;
performing, with the generative model, a reverse phase process that removes noise from one or more training samples that were used to train the generative model;
in conjunction with the reverse phase process, consulting, by the generative model, a guidance loss; and
generating, based in part on the guidance loss, a set of samples, and one of the samples comprises a tensor network that represents the quantum circuit.

2. The method as recited in claim 1, wherein the generative model is a diffusion model.

3. The method as recited in claim 1, wherein the generative model was trained by a forward phase process comprising adding noise to the one or more training samples.

4. The method as recited in claim 1, wherein the training dataset comprised a group of tuples (Tᵢₙₚᵤₜ, C), where Tᵢₙₚᵤₜ is a known representation of a tensor network, and C is a quantum circuit to which that representation corresponds.

5. The method as recited in claim 1, wherein the tensor network is a contracted tensor network created from a group of tensor networks.

6. The method as recited in claim 1, wherein the generative model comprises an encoder that uses the feature set as a basis to generate the guidance loss.

7. The method as recited in claim 1, wherein the reverse phase process is performed using Markov chains.

8. The method as recited in claim 1, wherein the tensor network generated as part of one of the samples is a compressed version of the quantum circuit.

9. The method as recited in claim 1, wherein the reverse phase process is performed using a pure noisy input.

10. The method as recited in claim 1, wherein the generative model is operable to generate the tensor network representative of the quantum circuit, using only the feature set of the quantum circuit as the input.

11. A non-transitory storage medium having stored therein instructions that are executable by one or more hardware processors to perform operations comprising:
providing an input to a generative model that was trained using a training dataset, and the input comprises a feature set of a quantum circuit;
performing, with the generative model, a reverse phase process that removes noise from one or more training samples that were used to train the generative model;
in conjunction with the reverse phase process, consulting, by the generative model, a guidance loss; and
generating, based in part on the guidance loss, a set of samples, and one of the samples comprises a tensor network that represents the quantum circuit.

12. The non-transitory storage medium as recited in claim 11, wherein the generative model is a diffusion model.

13. The non-transitory storage medium as recited in claim 11, wherein the generative model was trained by a forward phase process comprising adding noise to the one or more training samples.

14. The non-transitory storage medium as recited in claim 11, wherein the training dataset comprised a group of tuples (Tᵢₙₚᵤₜ, C), where Tᵢₙₚᵤₜ is a known representation of a tensor network, and C is a quantum circuit to which that representation corresponds.

15. The non-transitory storage medium as recited in claim 11, wherein the tensor network is a contracted tensor network created from a group of tensor networks.

16. The non-transitory storage medium as recited in claim 11, wherein the generative model comprises an encoder that uses the feature set as a basis to generate the guidance loss.

17. The non-transitory storage medium as recited in claim 11, wherein the reverse phase process is performed using Markov chains.

18. The non-transitory storage medium as recited in claim 11, wherein the tensor network generated as part of one of the samples is a compressed version of the quantum circuit.

19. The non-transitory storage medium as recited in claim 11, wherein the reverse phase process is performed using a pure noisy input.

20. The non-transitory storage medium as recited in claim 11, wherein the generative model is operable to generate the tensor network representative of the quantum circuit, using only the feature set of the quantum circuit as the input.
